(19) United States
(12) Patent Application Publication
(10) Pub. No.: US 2010/0097794 A1
(43) Pub. Date: Apr. 22, 2010

(54) LED lamp structure for reducing multiple shadows

(75) Inventors: Kuo-Hsin Teng, Taipei (TW); Hon-Lun Chen, Taipei (TW); Jyh-Way Wu, Taipei (TW)

Correspondence Address: Juan Carlos A. Marquez;c/o Stites & Harbison PLLC, 1199 North Fairfax Street, Suite 900, Alexandria, VA, 22314-1437, US

(73) Assignee: Prodisc Technology Inc.

(21) Appl. No.: 12/289,779

(22) Filed: Nov. 4, 2008

Related U.S. Application Data
(60) Provisional application No. 60/996,928, filed on Dec. 11, 2007.

(51) Int. Cl. F21V 9/00; F21V 1/00

(52) U.S. Cl. 362/231; 362/235; 362/294

(57) ABSTRACT

An LED (Light-Emitting Diode) lamp structure for reducing multiple shadows comprises a supporting element, LED light sources and a first reflector. The LED light sources are arranged on the supporting element and the first reflector is arranged in light paths of the LED light sources so that lights emitted from the LED light sources can be scattered or diffused (reflected) by the first reflector toward all directions. An object that is placed under the LED lamp structure can be illuminated by the lights while production of multiple shadows of the object can be reduced.

1) Current ceiling lights, office lighting, and basic non-shadow lighting (medical use) have a problem with multiple shadows produced through the multiple light source used. This is more evident through the use of LEDs because of the 2D shape of LED and its limited use in a 360 degrees environment.
2) Our patent involves a design of the setup of the lighting to produce a reduced to no multiple shadowing effects with the use of LEDs as the office light source.
3) The design includes a circular shaped lighting and an elongated shaped lighting.
4) If the light fixture requires that the light source be exposed through a downward apparatus, the light illuminate can reflect off, or travel through, a reflector, lens reflector, or fiber optic tubing etc. to guide light not directly emitting from the light fixture.
5) The LEDs are attached to a specially design heat sink or heat pipe etc. to transfer the heat produced by the LEDs to somewhere cooler and evenly distribute the heat produced. If a heat pipe were used, the heat sink would be attached at the edge of the heat pipe.
6) In the case of the heat pipe, the shape of the heat pipe that has the LEDs applied to it is not limited to any one shape but the only requirement is to have a flat surface to mount the LED and the MPCB (Metallic PCB) to that particular surface.
7) The shape of the reflector has no limitation as long as the light reflected from the LED is all transferred in a downward direction.
8) Elongated version non-shadow lighting requires the setup of the LED to be a rectangular setup.
9) The heat sinks for the elongated version would be in a horizontal U-shaped figure and carries the heat produced by the LED to a cooler region.
10) The light produced by the LED would reflect off the reflector and produce a non-shadow lighting.
11) For LEDs used in a downward direction, a reflector, a lens reflector, or fiber optic tubing etc., can be used to deflect the light upwards and then reflect off the larger reflector downwards and still maintain a no shadow effect. The end result of this setup would produce a lower illumination intensity due to the multiple reflections of the respect components, reflector to reflector, lens reflector to reflector, or fiber optic tubing to reflector.
12) The position of the LEDs are not limited to a downward, or a direct sideways, direction. The LEDs can expose upwards, or slanted.
13) The upward expose of the LEDs can directly reflect off the reflector and produce a no shadow effect.
14) The slanted LEDs can also expose directly off the reflector but the setup would be more in an angle.
15) There is no limitation to the shape of the exterior shell.
16) The type of material used in the reflector can be a mirror effect, rigid surface, or polarizer etc.
17) The Fresnel lens, diffuser, or polarizer, may be used as a single, or multiple, optical solution for the lighting system as an optical module.

The objective of this patent:

Develop a lighting system device that produces a no multiple shadows light when the light source exposes its illumination to any object. The end result is to produce a light that is close and similar to the lights used in medical surgery where doctors need no shadows when performing operations.

The design of the no multiple shadows light is not limited to only residential lighting but also used in fixtures such as office ceiling lighting, medical lighting, and decorative lighting. The end result of this product would produce a light that is soothing to the eyes of the user because of the lack of multiple shadows produced.

The marketing of this product is limitless due the advantage of having a no multiple shadows lighting produced by LEDs. From a user standpoint, the most important problem of the LEDs is the multiple shadows. Multiple shadows are produced by using multiple LEDs to produce a single light. LEDs are not a continuous light source, but a dot of light due to the P-N junction of the semiconductor. By developing a no multiple shadow light from LEDs allows this disadvantage to disappear and give a new market to LED lighting. The final product of the no multiple shadow lighting can be produced as a final product or a module that can be placed into any form of LED setup as long as the setup matches the modules specifications.

Some changes that may occur with this patent include:

1) Different type lighting design

2) Other types of LED combination

3) Different types of heat transfer units

4) Different types of material used to dissipate the heat

### FIRST PREFERRED EMBODIMENT

As shown in FIG. 1A, an LED lamp structure for reducing multiple shadows according to a first preferred embodiment of the present invention comprises a supporting element, a plurality of LED light sources, and a first reflector 11.

According to FIG. 2A, the supporting element may be a column with a sectional shape of a triangle, a tetragon, a pentagon, a hexagon or a polygon. In fact, the supporting element may have the sectional shape formed into any shape, as long as the sectional shape includes at least one plane to receive the LED light sources. As can be seen in FIG. 1A, the supporting element is settled on a symmetry axis of the LED lamp structure and passing through a center of the first reflector 11.

The supporting element may be a solid metal component, a hollow metal component or a heat pipe. The supporting element may be made of copper, diamond-like carbon, or any highly thermal conductive material. Besides, the supporting element serves not only to bear the LED light sources, but also to facilitate heat dissipation from the LED light sources. Referring to FIG. 1A, in order to speed up heat conduction and dissipation from the supporting element, a plurality of heat-sink fins may be arranged at an end of the supporting element that juts out the first reflector 11 so as to provide a relatively large heat radiating area.

According to FIG. 2B, the supporting element may be a hollow metal component made of the highly thermal conductive material. Thus, heat generated by the LED light sources settled on lateral surfaces of the supporting element can be transferred via the supporting element to an inner surface of the supporting element and then be taken away from the LED light sources by air convection. As shown in FIG. 1B, in order to further speed up air convection, a fan may be further provided at the end of the supporting element that juts out the first reflector 11, so that when the fan exhausts out heated air, cool air can be drawn into the hollow portion of the supporting element.

The LED light sources, settled on the lateral surfaces of the supporting element, may be white light-emitting diodes or a combination of light-emitting diodes of various colors. Therein, a color temperature of the LED light sources can be adjusted by altering a light intensity of the light-emitting diode(s) of each color. Besides, the LED light sources may be preset on a PCB (Printed Circuit Board) or an MPCB (Metallic Printed Circuit Board) and then affixed to the lateral surfaces of the supporting element.

The first reflector 11 may have a dome shape, as shown in FIGS. 1A and 1B. The first reflector 11 has a rugged inner surface for specular reflection or polarization. The rugged inner surface may have a regular microstructure or an irregular microstructure. The first reflector 11 is arranged at a location where it is allowed to receive and reflect lights emitted from the LED light sources. When the lights emitted by the LED light sources cast on the rugged inner surface of the first reflector 11, the lights are irregularly scattered or diffused (reflected) by the rugged inner surface outward from the LED lamp structure. Since the lights are irregularly scattered or diffused (reflected) by the rugged inner surface in all directions, the lights are diverged away from the symmetry axis or converged toward the symmetry axis, thereby achieving uniform illumination of the LED lamp structure.

Generally speaking, since a conventional LED lamp structure has lights emitted by LED light sources directly casting downward, and each light-emitting diode functions as an independent point light source, the lights emitted from the plural LEDs of the conventional LED lamp structure give an object placed therebelow multiple shadows. Hence, the conventional LED lamp structure tends to afflict a user with visual uncomfortableness after a long term of use.

Different from the conventional LED lamp structure, the LED lamp structure of the present embodiment has the lights emitted from the LED light sources irregularly scattered or diffused (reflected) by the rugged inner surface of the first reflector 11 so that the lights cast on an object under the LED lamp structure coming in all directions but not directly casting vertically downward on the object. Thereby, the object placed under the disclosed LED lamp structure is illuminated by the lights from all directions, thus reducing multiple shadows of the object. Hence, a user of the disclosed LED lamp structure is free from visual uncomfortableness caused by multiple shadows of the object.

Besides, in order to further reduce multiple shadows of an object, a transparent housing 13 may be provided at an end of the first reflector 11 for further reflecting the lights. The transparent housing 13 may be a Fresnel lens, a diffuser plate or a polarizer.

### SECOND PREFERRED EMBODIMENT

As shown in FIG. 3A, an LED lamp structure for reducing multiple shadows according to a second preferred embodiment of the present invention comprises a supporting element, a plurality of LED light sources, and a second reflector 12.

Referring to FIG. 3B, the supporting element is formed as a U-shaped piece that has a first part, a connecting portion, and a second part. Therein, the first part includes a first lateral surface and a second lateral surface facing each other. The first lateral surface of the first part carries the LED light sources. The supporting element may have a sectional shape of a triangle, a tetragon, a pentagon, a hexagon or a polygon. In fact, the supporting element may have the sectional shape formed into any shape, as long as the sectional shape includes at least one plane to receive the LED light sources.

As shown in FIG. 2A, the supporting element may be a solid metal component, a hollow metal component or a heat pipe. The supporting element may be made of copper, diamond-like carbon, or any highly thermal conductive material. Referring to FIG. 3B, the supporting element serves not only to bear the LED light sources, but also to facilitate heat dissipation from the LED light sources. In order to speed up heat conduction and dissipation from the supporting element, a plurality of heat-sink fins may be arranged at the second part of the supporting element so as to provide a relatively large heat radiating area.

According to FIG. 2B, the supporting element may be a hollow metal component. Thus, heat generated by the LED light sources settled on the surface of the supporting element can be transferred via the supporting element made of the highly thermal conductive material to an inner surface of the supporting element and then be taken away from the LED light sources by air convection.

As can be seen in FIG. 3A, the LED light sources, settled on the first lateral surface of the supporting element, may be white light-emitting diodes or a combination of light-emitting diodes of various colors. Therein, a color temperature of the LED light sources can be adjusted by altering a light intensity of the light-emitting diode(s) of each color. Besides, the LED light sources may be preset on a PCB (Printed Circuit Board) or an MPCB (Metallic Printed Circuit Board) and then affixed to the first lateral surface of the supporting element.

According to FIG. 3A, the second reflector 12 may have an elongate body and a rugged inner surface for specular reflection or polarization. The rugged inner surface may have a regular microstructure or an irregular microstructure. The second reflector 12 is arranged at a location where it is allowed to receive and reflect lights emitted by the LED light sources settled on the first lateral surface. When the lights emitted by the LED light sources cast on the rugged inner surface of the second reflector 12, the lights are irregularly scattered or diffused (reflected) by the rugged inner surface outward from the LED lamp structure in all directions. Since the lights are irregularly scattered or diffused (reflected) by the rugged inner surface in all directions, the lights are diverged away from the symmetry axis or converged toward the symmetry axis, thereby achieving uniform illumination of the LED lamp structure.

Generally speaking, since a conventional LED lamp structure has lights emitted by LED light sources directly casting downward, and each light-emitting diode functions as an independent point light source, the lights emitted from the plural LEDs of the conventional LED lamp structure give an object placed therebelow multiple shadows. Hence, the conventional LED lamp structure tends to afflict a user with visual uncomfortableness after a long term of use.

Different from the conventional LED lamp structure, the LED lamp structure of the present embodiment has the lights emitted from the LED light sources irregularly scattered or diffused (reflected) by the rugged inner surface of the second reflector 12 so that the lights cast on an object under the LED lamp structure coming in all directions but not directly casting vertically downward on the object. Thereby, the object placed under the disclosed LED lamp structure is illuminated by the lights from all directions, thus reducing multiple shadows of the object. Hence, a user of the disclosed LED lamp structure is free from visual uncomfortableness caused by multiple shadows of the object.

Besides, as shown in FIG. 4, an additional second reflector 12 may be so arranged that the two second reflectors 12 face each other to form a semicircular, arched body while additional LED light sources are arranged on the second lateral surface of the supporting element. Thus, the lights emitted by the LED light sources on the second lateral surface are scattered or diffused (reflected) by the rugged inner surfaces of the additional second reflector 12.

Besides, in order to further reduce multiple shadows of an object, as can be seen in FIGS. 3A and 4, a transparent housing 13 may be provided at an end of the second reflector 12 for further reflecting the lights. The transparent housing 13 may be a Fresnel lens, a diffuser plate or a polarizer.

### THIRD PREFERRED EMBODIMENT

As shown in FIGS. 5A, 5B, and 5C, an LED lamp structure for reducing multiple shadows according to a third preferred embodiment of the present invention comprises a supporting element, a first board 14, a plurality of LED light sources, a first reflecting member 15, and a first reflector 11.

According to FIG. 2A, the supporting element may be a column with a sectional shape of a triangle, a tetragon, a pentagon, a hexagon or a polygon. Referring to FIGS. 5A, 5B, and 5C, the supporting element is settled on a symmetry axis of the LED lamp structure and passing through a center of the first reflector 11. The supporting element may be a solid metal component, a hollow metal component or a heat pipe. The supporting element may be made of copper, diamond-like carbon, or any highly thermal conductive material.

According to FIGS. 5A, 5B, and 5C, the first board 14 is coupled with an end of the supporting element for carrying the LED light sources. The first board 14 has a first surface 141 and a second surface 142, wherein the LED light sources are arranged on the first surface 141 so that lights emitted by the LED light sources cast downward. The first board 14 is made of a same material as that used to make the supporting element. Besides, the supporting element and the first board 14 serve not only to bear the LED light sources, but also to facilitate heat dissipation from the LED light sources. In order to speed up heat conduction and dissipation from the supporting element, a plurality of heat-sink fins may be arranged at an end of the supporting element that juts out the first reflector 11 so as to provide a relatively large heat radiating area.

According to FIG. 2B, the supporting element may be a hollow metal component made of the highly thermal conductive material. Thus, heat generated by the LED light sources settled on a lateral surface of the supporting element can be transferred via the supporting element to an inner surface of the supporting element and then be taken away from the LED light sources by air convection. As shown in FIG. 1B, in order to further speed up air convection, a fan may be further provided at the end of the supporting element that juts out the first reflector 11, so that when the fan exhausts out heated air, cool air can be drawn into the hollow portion of the supporting element.

The LED light sources, settled on the first surface 141 of the first board 14, may be white light-emitting diodes or a combination of light-emitting diodes of various colors. Therein, a color temperature of the LED light sources can be adjusted by altering a light intensity of the light-emitting diode(s) of each color. Besides, the LED light sources may be preset on a PCB (Printed Circuit Board) or an MPCB (Metallic Printed Circuit Board) and then affixed to the first surface 141 of the first board 14.

As shown in FIGS. 5A, 5B, and 5C, the first reflector 11 has a rugged inner surface for specular reflection or polarization. The rugged inner surface may have a regular microstructure or an irregular microstructure. The first reflecting member 15 is settled at a location where the first reflecting member 15 alters light-emitting directions of the LED light sources. The first reflecting member 15 may be a reflector, a reflector lens, or a fiber optic tube.

As shown in FIG. 5A, the first reflecting member 15 is a reflector arranged in light paths of the LED light sources and serves to reflect all the lights emitted by the LED light sources toward the first reflector 11. When the lights emitted by the LED light sources cast on the rugged inner surface of the first reflector 11, the lights are irregularly scattered or diffused (reflected) by the rugged inner surface outward from the LED lamp structure. Since the lights are irregularly scattered or diffused (reflected) by the rugged inner surface in all directions, the lights are diverged away from the symmetry axis or converged toward the symmetry axis, thereby achieving uniform illumination of the LED lamp structure.

According to FIGS. 5B and 5C, the first reflecting member 15 is a reflector lens or a fiber optic tube arranged in light paths of the LED light sources so as to reflect or guide one part of the lights emitted by the LED light sources toward the first reflecting member 15 and make the rest of the lights emitted by the LED light sources directly cast downward.

When the part of the lights emitted by the LED light sources are reflected or guided to the first reflector 11 by the first reflecting member 15, due to the rugged inner surface of the first reflector 11, the lights are irregularly scattered or diffused (reflected) by the rugged inner surface outward from the LED lamp structure. Since the lights are irregularly scattered or diffused (reflected) by the rugged inner surface in all directions, the lights are diverged away from the symmetry axis or converged toward the symmetry axis, thereby achieving uniform illumination of the LED lamp structure.

Generally speaking, since a conventional LED lamp structure has lights emitted by LED light sources directly casting downward, and each light-emitting diode functions as an independent point light source, the lights emitted from the plural LEDs of the conventional LED lamp structure give an object placed therebelow multiple shadows. Hence, the conventional LED lamp structure tends to afflict a user with visual uncomfortableness after a long term of use.

Different from the conventional LED lamp structure, the LED lamp structure of the present embodiment has the lights emitted from the LED light sources irregularly scattered or diffused (reflected) by the rugged inner surface of the first reflector 11 so that not all of the lights directly cast vertically downward on the object but cast on an object under the LED lamp structure in all directions. Thereby, the object placed under the disclosed LED lamp structure is illuminated by the lights from all directions, thus reducing multiple shadows of the object. Hence, a user of the disclosed LED lamp structure is free from visual uncomfortableness caused by multiple shadows of the object.

Besides, in order to further reduce multiple shadows of an object, as shown in FIGS. 5A, 5B, and 5C, a transparent housing 13 may be provided at an end of the first reflector 11 for further reflecting the lights. The transparent housing 13 may be a Fresnel lens, a diffuser plate or a polarizer.

### FOURTH PREFERRED EMBODIMENT

As shown in FIG. 6, an LED lamp structure for reducing multiple shadows according to a fourth preferred embodiment of the present invention comprises a supporting element, a first board 14, a plurality of LED light sources, and a first reflector 11.

According to FIG. 2A, the supporting element may be a column with a sectional shape of a triangle, a tetragon, a pentagon, a hexagon or a polygon. As can be seen in FIG. 6, the supporting element is settled on a symmetry axis of the LED lamp structure and passing through a center of the first reflector 11. The supporting element may be a solid metal component, a hollow metal component or a heat pipe. The supporting element may be made of copper, diamond-like carbon, or any highly thermal conductive material.

According to FIG. 6, the first board 14 is coupled with an end of the supporting element for carrying the LED light sources. The first board 14 has a first surface 141 and a second surface 142, wherein the LED light sources are arranged on the second surface 142 so that lights emitted by the LED light sources cast upward. The first board 14 is made of a same material as that used to make the supporting element. Besides, the supporting element and the first board 14 serve not only to bear the LED light sources, but also to facilitate heat dissipation from the LED light sources. In order to speed up heat conduction and dissipation from the supporting element, a plurality of heat-sink fins may be arranged at an end of the supporting element that juts out the first reflector 11 so as to provide a relatively large heat radiating area.

According to FIG. 2B, the supporting element may be a hollow metal component made of the highly thermal conductive material. Thus, heat generated by the LED light sources settled on a lateral surface of the supporting element can be transferred via the supporting element to an inner surface of the supporting element and then be taken away from the LED light sources by air convection. As shown in FIG. 1B, in order to further speed up air convection, a fan may be further provided at the end of the supporting element that juts out the first reflector 11, so that when the fan exhausts out heated air, cool air can be drawn into the hollow portion of the supporting element.

The LED light sources, settled on the second surface 142 of the first board 14, may be white light-emitting diodes or a combination of light-emitting diodes of various colors. Therein, a color temperature of the LED light sources can be adjusted by altering a light intensity of the light-emitting diode(s) of each color. Besides, the LED light sources may be preset on a PCB (Printed Circuit Board) or an MPCB (Metallic Printed Circuit Board) and then affixed to the second surface 142 of the first board 14.

The first reflector 11 may have a dome shape, as shown in FIG. 6. The first reflector 11 has a rugged inner surface for specular reflection or polarization. The rugged inner surface may have a regular microstructure or an irregular microstructure. Thereby, the lights emitted by the LED light sources are irregularly scattered or diffused (reflected) outward from the LED lamp structure by the rugged inner surface of the first reflector 11. Since the lights are irregularly scattered or diffused (reflected) by the rugged inner surface in all directions, the lights are diverged away from the symmetry axis or converged toward the symmetry axis, thereby achieving uniform illumination of the LED lamp structure.

Generally speaking, since a conventional LED lamp structure has lights emitted by LED light sources directly casting downward, and each light-emitting diode functions as an independent point light source, the lights emitted from the plural LEDs of the conventional LED lamp structure give an object placed therebelow multiple shadows. Hence, the conventional LED lamp structure tends to afflict a user with visual uncomfortableness after a long term of use.

Different from the conventional LED lamp structure, the LED lamp structure of the present embodiment has the lights emitted from the LED light sources irregularly scattered or diffused (reflected) by the rugged inner surface of the first reflector 11 so that not all of the lights are directly projected vertically downward to the object but the lights cast on an object under the LED lamp structure in all directions. Thereby, the object placed under the disclosed LED lamp structure is illuminated by the lights from all directions, thus reducing multiple shadows of the object. Hence, a user of the disclosed LED lamp structure is free from visual uncomfortableness caused by multiple shadows of the object.

Besides, in order to further reduce multiple shadows of an object, as can be seen in FIG. 6, a transparent housing 13 may be provided at an end of the first reflector 11 for further reflecting the lights. The transparent housing 13 may be a Fresnel lens, a diffuser plate or a polarizer.

### FIFTH PREFERRED EMBODIMENT

As shown in FIG. 7, an LED lamp structure for reducing multiple shadows according to a fifth preferred embodiment of the present invention comprises a supporting element, a first board 14, a second board 16, a plurality of LED light sources, and a first reflector 11.

According to FIG. 2A, the supporting element may be a column with a sectional shape of a triangle, a tetragon, a pentagon, a hexagon or a polygon. As can be seen in FIG. 7, the supporting element is settled on a symmetry axis of the LED lamp structure and passing through a center of the first reflector 11. The supporting element may be a solid metal component, a hollow metal component or a heat pipe. The supporting element may be made of copper, diamond-like carbon, or any highly thermal conductive material.

According to FIG. 7, the first board 14 and the second board 16 are coupled with an end of the supporting element with an included angle formed therebetween. The first board 14 and the second board 16 each carry the LED light sources. The first board 14 has a first surface 141 and a second surface 142, while the second board 16 has a third surface 161 and a fourth surface 162. The LED light sources are arranged on the second surface 142 and the fourth surface 162 so that lights emitted by the LED light sources cast upward.

The first board 14 and the second board 16 are made of a same material as that used to make the supporting element. Besides, the supporting element, the first board 14, and the second board 16 serve not only to bear the LED light sources, but also to facilitate heat dissipation from the LED light sources. In order to speed up heat conduction and dissipation from the supporting element, a plurality of heat-sink fins may be arranged at an end of the supporting element that juts out the first reflector 11 so as to provide a relatively large heat radiating area.

According to FIG. 2B, the supporting element may be a hollow metal component made of the highly thermal conductive material. Thus, heat generated by the LED light sources settled on a lateral surface of the supporting element can be transferred via the supporting element to an inner surface of the supporting element and then be taken away from the LED light sources by air convection. As shown in FIG. 1B, in order to further speed up air convection, a fan may be further provided at the end of the supporting element that juts out the first reflector 11, so that when the fan exhausts out heated air, cool air can be drawn into the hollow portion of the supporting element.

The LED light sources, settled on the second surface 142 of the first board 14, may be white light-emitting diodes or a combination of light-emitting diodes of various colors. Therein, a color temperature of the LED light sources can be adjusted by altering a light intensity of the light-emitting diode(s) of each color. Besides, the LED light sources may be preset on PCBs (Printed Circuit Boards) or MPCBs (Metallic Printed Circuit Boards) and then affixed to the second surface 142 of the first board 14 and the fourth surface 162 of the second board 16.

The first reflector 11 may have a dome shape, as shown in FIG. 7. The first reflector 11 has a rugged inner surface for specular reflection or polarization. The rugged inner surface may have a regular microstructure or an irregular microstructure. Thereby the lights emitted by the LED light sources are irregularly scattered or diffused (reflected) by the rugged inner surface outward from the LED lamp structure by the first reflector 11. Since the lights are irregularly scattered or diffused (reflected) by the rugged inner surface, the lights are projected in all directions, thereby achieving uniform illumination of the LED lamp structure.

Generally speaking, since a conventional LED lamp structure has lights emitted by LED light sources directly casting downward, and each light-emitting diode functions as an independent point light source, the lights emitted from the plural LEDs of the conventional LED lamp structure give an object placed therebelow multiple shadows. Hence, the conventional LED lamp structure tends to afflict a user with visual uncomfortableness after a long term of use.

Different from the conventional LED lamp structure, the LED lamp structure of the present embodiment has the lights emitted from the LED light sources irregularly scattered or diffused (reflected) by the rugged inner surface of the first reflector 11 so that the lights cast on an object under the LED lamp structure coming in all directions but not directly casting vertically downward on the object. Thereby, the object placed under the disclosed LED lamp structure is illuminated by the lights from all directions, thus reducing multiple shadows of the object. Hence, a user of the disclosed LED lamp structure is free from visual uncomfortableness caused by multiple shadows of the object.

Besides, in order to further reduce multiple shadows of an object, as can be seen in FIG. 7, a transparent housing 13 may be provided at an end of the first reflector 11 for further reflecting the lights. The transparent housing 13 may be a Fresnel lens, a diffuser plate or a polarizer.

### BRIEF DESCRIPTION OF THE DRAWINGS

FIG. 1A shows a first embodiment of an LED lamp structure for reducing multiple shadows according to the present invention;

FIG. 1B shows another aspect of the first embodiment of the LED lamp structure for reducing multiple shadows according to the present invention;

FIG. 2A shows some aspects of a supporting element in the LED lamp structure for reducing multiple shadows according to the present invention;

FIG. 2B shows some other aspects of the supporting element in the LED lamp structure for reducing multiple shadows according to the present invention;

FIG. 3A shows a second embodiment of an LED lamp structure for reducing multiple shadows according to the present invention;

FIG. 3B shows an aspect of a supporting element in the LED lamp structure for reducing multiple shadows according to the present invention;

FIG. 4 shows another aspect of the second embodiment of the LED lamp structure for reducing multiple shadows according to the present invention;

FIG. 5A shows a third embodiment of the LED lamp structure for reducing multiple shadows according to the present invention;

FIG. 5B shows another aspect of the third embodiment of the LED lamp structure for reducing multiple shadows according to the present invention;

FIG. 5C shows another aspect of the third embodiment of the LED lamp structure for reducing multiple shadows according to the present invention;

FIG. 6 shows a fourth embodiment of the LED lamp structure for reducing multiple shadows according to the present invention; and

FIG. 7 shows a fifth embodiment of the LED lamp structure for reducing multiple shadows according to the present invention.

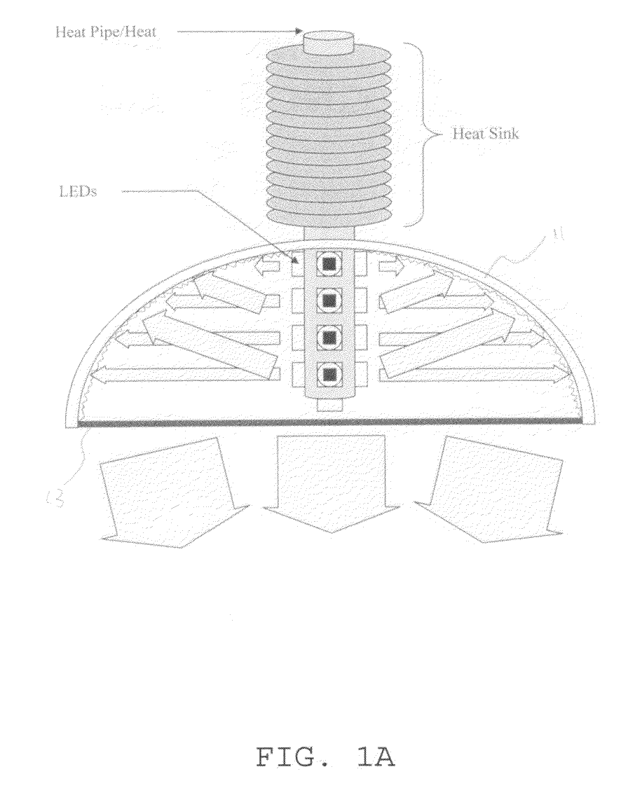

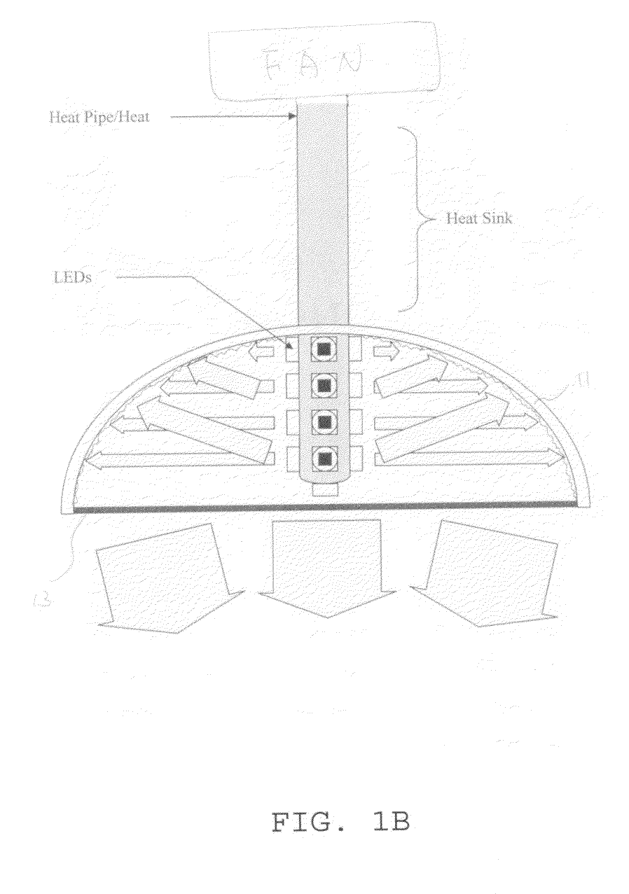

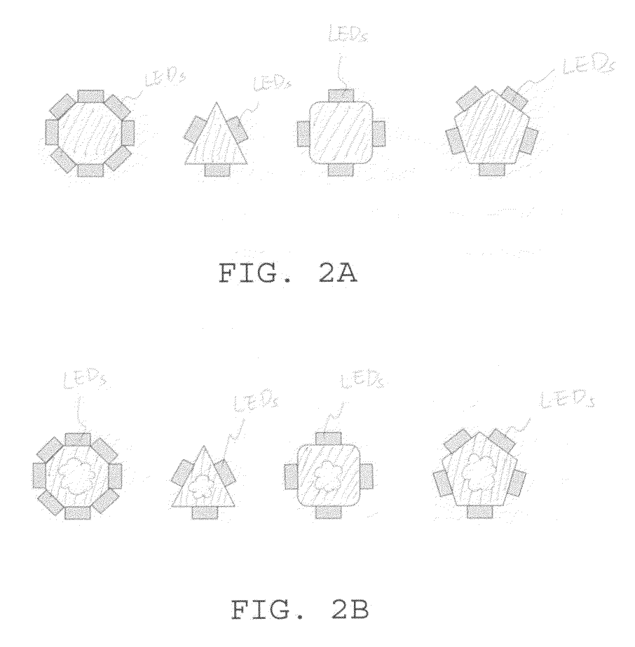

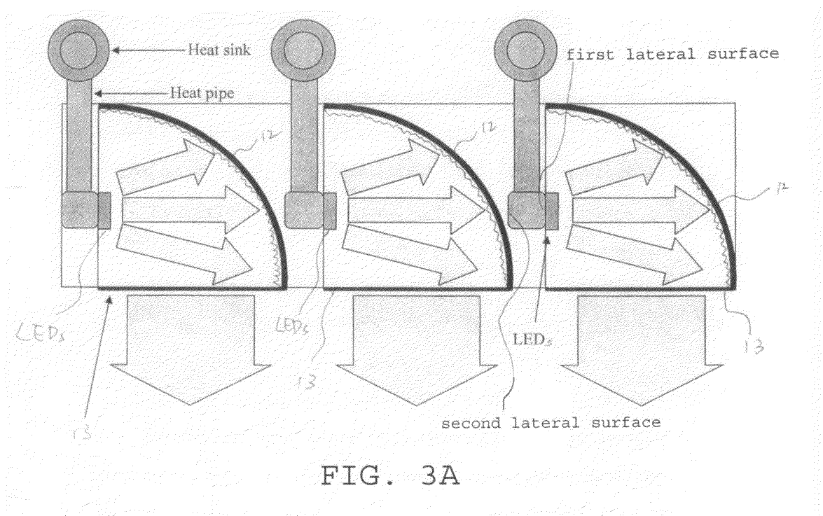

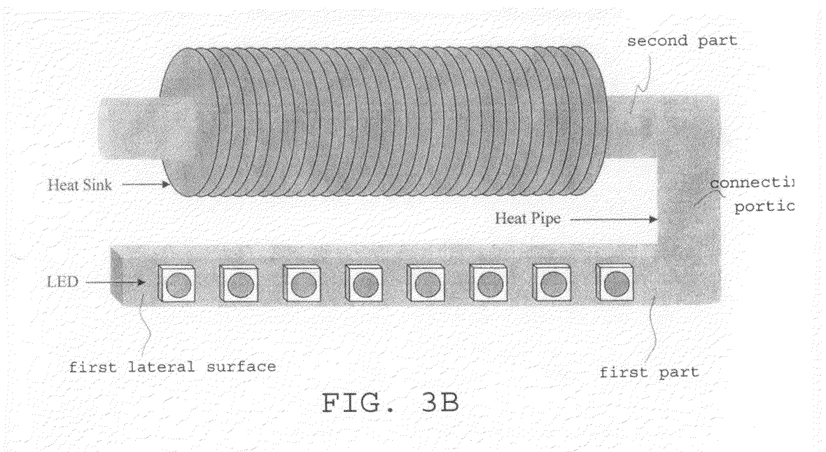

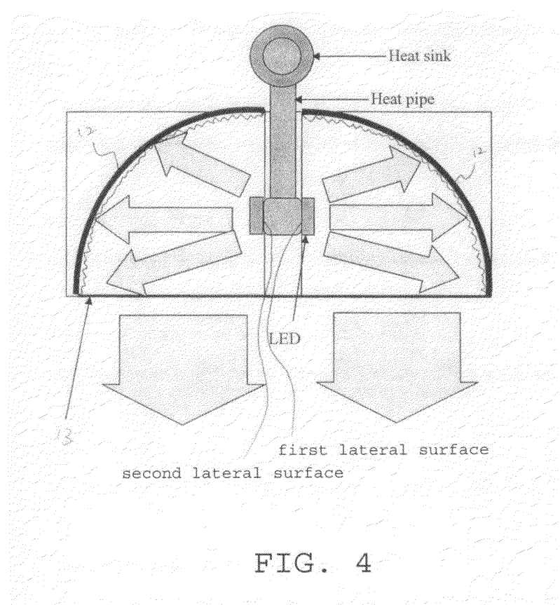

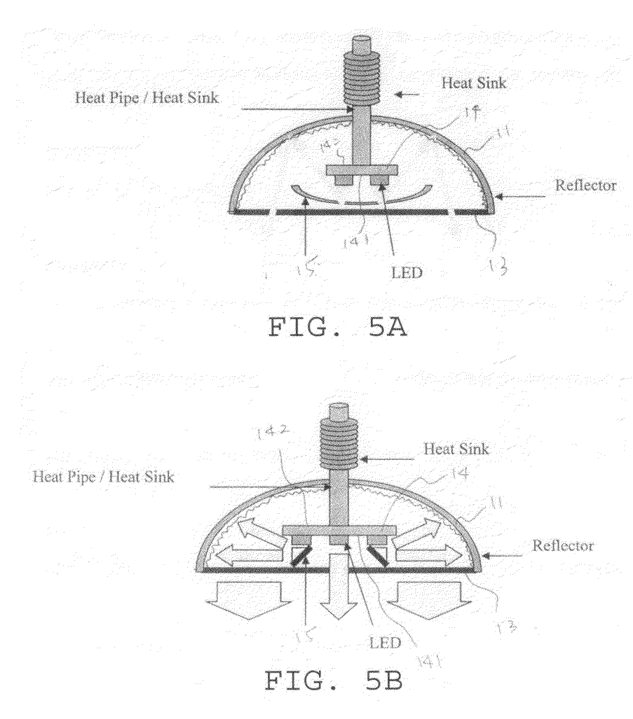

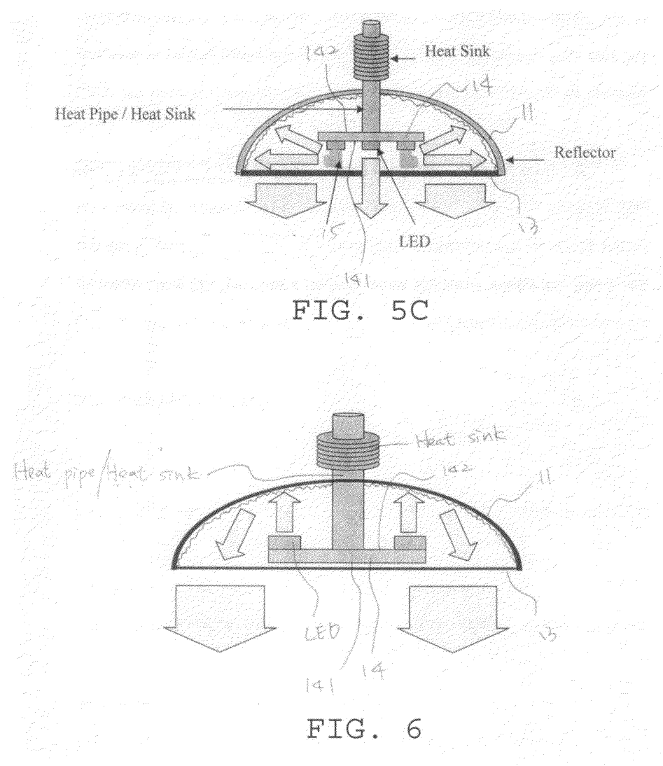

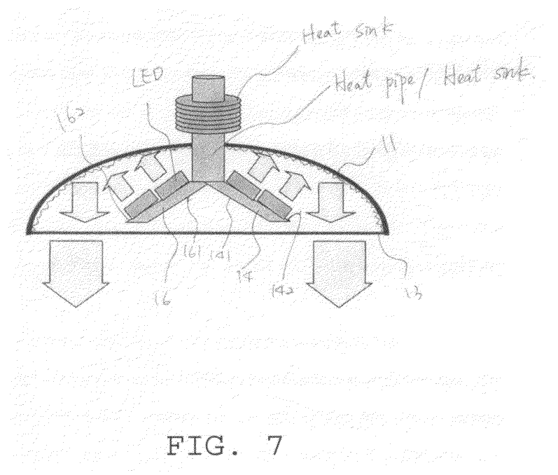

What is claimed is:

1. An LED (Light-Emitting Diode) lamp structure for reducing multiple shadows, comprising:
a supporting element formed as a column that has at least one plane and a central axis;
a plurality of LED light sources settled on the plane; and
a first reflector, which has a symmetry axis coinciding with the central axis and a rugged inner surface, settled in light paths of the LED light sources.

2. The LED lamp structure of claim 1, wherein the supporting element is a polygonal column, a solid metal component, a hollow metal component, or a heat pipe.

3. The LED lamp structure of claim 1, wherein the supporting element is a hollow metal component and a fan is provided at a second end of the supporting element.

4. The LED lamp structure of claim 1, wherein the supporting element is made of copper, aluminum, or diamond-like carbon.

5. The LED lamp structure of claim 1, wherein the supporting element is made of a material having a thermal conductivity ranging from 100 to 2000 W/m-K.

6. The LED lamp structure of claim 1, wherein the supporting element further has a plurality of heat-sink fins.

7. The LED lamp structure of claim 1, wherein the LED light sources are white light-emitting diodes or a combination of light-emitting diodes of various colors.

8. The LED lamp structure of claim 1, wherein the LED light sources are further arranged on a PCB (Printed Circuit Board) or an MPCB (Metallic Printed Circuit Board).

9. The LED lamp structure of claim 1, wherein the first reflector has a dome shape.

10. The LED lamp structure of claim 1, wherein the rugged inner surface has a regular microstructure or an irregular microstructure.

11. The LED lamp structure of claim 1, further comprising a transparent housing settled at an end of the first reflector.

12. The LED lamp structure of claim 11, wherein the transparent housing is a Fresnel lens, a diffuser plate or a polarizer.

13. An LED (Light-Emitting Diode) lamp structure for reducing multiple shadows, comprising:
a supporting element formed as a U-shaped piece that has: a first part, which includes a first lateral surface and a second lateral surface, a connecting portion, which has one end thereof coupled with the first part to form an integral piece, and a second part, which is coupled with another end of the connecting portion to form an integral piece;
a plurality of LED light sources settled on the first lateral surface; and
at least one second reflector, which has a rugged inner surface, settled in light paths of the LED light sources.

14. The LED lamp structure of claim 13, wherein the supporting element is a polygonal column, a solid metal component, a hollow metal component, or a heat pipe.

15. The LED lamp structure of claim 13, wherein the supporting element is a hollow metal component and a fan is provided at a second end of the second part.

16. The LED lamp structure of claim 13, wherein the supporting element is made of copper, aluminum, or diamond-like carbon.

17. The LED lamp structure of claim 13, wherein the supporting element is made of a material having a thermal conductivity ranging from 100 to 2000 W/m-K.

18. The LED lamp structure of claim 13, wherein the second part further has a plurality of heat-sink fins.

19. The LED lamp structure of claim 13, wherein the LED light sources are white light-emitting diodes or a combination of light-emitting diodes of various colors.

20. The LED lamp structure of claim 13, wherein the LED light sources are further arranged on a PCB (Printed Circuit Board) or an MPCB (Metallic Printed Circuit Board).

21. The LED lamp structure of claim 13, wherein the second reflector has an elongate shape.

22. The LED lamp structure of claim 13, wherein the rugged inner surface has a regular microstructure or an irregular microstructure.

23. The LED lamp structure of claim 13, further comprising a transparent housing settled at an end of the second reflector.

24. The LED lamp structure of claim 23, wherein the transparent housing is a Fresnel lens, a diffuser plate or a polarizer.

25. The LED lamp structure of claim 13, comprising two said second reflectors that face each other to form a semicircular, arched body, wherein additional said LED light sources are arranged on the second lateral surface.

26. An LED (Light-Emitting Diode) lamp structure for reducing multiple shadows, comprising:
a supporting element formed as a column that has at least one plane and a central axis;
at least one board coupled with a first end of the supporting element;
a plurality of LED light sources settled on the board; and
a first reflector, which has a symmetry axis coinciding with the central axis and a rugged inner surface, settled in light paths of the LED light sources.

27. The LED lamp structure of claim 26, wherein the supporting element is a polygonal column, a solid metal component, a hollow metal component, or a heat pipe.

28. The LED lamp structure of claim 26, wherein the supporting element is a hollow metal component and a fan is provided at a second end of the supporting element.

29. The LED lamp structure of claim 26, wherein the supporting element is made of copper, aluminum, or diamond-like carbon.

30. The LED lamp structure of claim 26, wherein the supporting element is made of a material having a thermal conductivity ranging from 100 to 2000 W/m-K.

31. The LED lamp structure of claim 26, wherein the supporting element further has a plurality of heat-sink fins.

32. The LED lamp structure of claim 26, wherein the board is made of copper, aluminum, or diamond-like carbon.

33. The LED lamp structure of claim 26, wherein the board is made of a material having a thermal conductivity ranging from 100 to 2000 W/m-K.

34. The LED lamp structure of claim 26, further comprising a first reflecting member, wherein the board is a first board having a first surface and a second surface, the second surface being coupled with the first end, and the LED light sources are arranged on the first surface so that lights of the LED light sources cast on the first reflecting member.

35. The LED lamp structure of claim 34, wherein the first reflecting member is a reverberator, a reflecting prism, or an optical fiber pipe.

36. The LED lamp structure of claim 26, wherein the board is a first board having a first surface and a second surface, the second surface being coupled with the first end, and the LED light sources are arranged on the second surface.

37. The LED lamp structure of claim 26, wherein the board comprises:
a second board having a third surface and a fourth surface, in which one end of the second board is coupled with the first end; and
a third board having a fifth surface and a sixth surface, in which one end of the third board is coupled with the first end.

38. The LED lamp structure of claim 37, wherein the LED light sources are arranged on the fourth surface and the sixth surface.

39. The LED lamp structure of claim 37, wherein the LED light sources are arranged on the third surface, the fourth surface, the fifth surface and the sixth surface.

40. The LED lamp structure of claim 26, wherein the LED light sources are white light-emitting diodes or a combination of light-emitting diodes of various colors.

41. The LED lamp structure of claim 26, wherein the LED light sources are further arranged on a PCB (Printed Circuit Board) or an MPCB (Metallic Printed Circuit Board).

42. The LED lamp structure of claim 26, wherein the first reflector has a dome shape.

43. The LED lamp structure of claim 26, wherein the rugged inner surface has a regular microstructure or an irregular microstructure.

44. The LED lamp structure of claim 26, further comprising a transparent housing settled at an end of the first reflector.

45. The LED lamp structure of claim 44, wherein the transparent housing is a Fresnel lens, a diffuser plate or a polarizer.
